(19) United States
(12) Patent Application Publication
(10) Pub. No.: US 2017/0178084 A1
(43) Pub. Date: Jun. 22, 2017

(54) REDUCING WAITING TIME FOR ACTIVITIES AT A VENUE

(71) Applicant: International Business Machines Corporation, Armonk, NY (US)

(72) Inventors: Priscilla BARREIRA AVEGLIANO, Sao Paulo (BR); Carlos Henrique CARDONHA, Sao Paulo (BR); Ricardo GUIMARAES HERRMANN, Consolacao (BR); Diego SANCHEZ GALLO, Sao Paulo (BR)

(21) Appl. No.: 14/978,488

(22) Filed: Dec. 22, 2015

(51) Int. Cl. G06Q 10/10

(52) U.S. Cl. CPC G06Q 10/1097

(57) ABSTRACT

Waiting time for the use of activities at a venue with multiple activities, such as an amusement park, is reduced by first receiving selections from visitors to the park using mobile phones, of desired activities and starting times. The selections are transmitted to a server which determines, for each user, waiting times associated with the desired starting times. The server then recommends alternative starting times for those activities. The alternative starting times are chosen to not only reduce the user's waiting time, but the waiting time for all users in the park. The alternative starting times are transmitted back to the mobile phones, where users can accept or reject the alternative starting times. The users are then placed into a virtual queue for each activity.

### FIELD OF THE DISCLOSURE

The disclosure relates to a system and method for reducing waiting times for activities at a venue, and more particularly to receiving a desired itinerary from mobile phone users visiting the venue, and providing an improved itinerary corresponding with the desired itinerary, but with shorter wait times.

### BACKGROUND OF THE DISCLOSURE

In U.S. Pat. No. 6,889,900, A handset is issued to a user, the detection system being arranged to detect the handset when it is within the coverage zone and to record the user of the handset as being in the queue. Queue load is subsequently used to provide recommended itineraries to visitors via the handsets.

In U.S. Pat. No. 7,212,983, itineraries are created for a party of visitors to a facility, the facility having multiple attractions. Visitors give answers to questions about their preferences, which is combined with authoritative information about their admission privileges, and information stored about the attractions and facility, to generate an itinerary.

In U.S. Patent Publication 2003/0093167, a portable module carried by a person or group to provide their location, and to communicate a paging message as part of a virtual queue system. U.S. Patent Publication 2011/0307547, additionally describes a virtual queue system.

In U.S. Pat. No. 7,787,965, a patron can have priority entry at a time selected by the patron. The patron requests allocation of a space on an attraction, and is provided a selection of available times.

In U.S. Pat. No. 8,082,165, guests carry a device which can be read to track their location. Guests can be offered incentives to enter less popular secondary attractions such as souvenir shops, and can have wait time reduced for a popular ride.

In U.S. Patent Publication 2013/0024203, a schedule and recommendations can be determined based on evaluating telemetry information, historic data, criteria and preferences. The schedule and recommendations enhance visits to points of interest.

### SUMMARY OF THE DISCLOSURE

In an embodiment of the disclosure, a method of reducing user waiting time for the use of activities at a venue having multiple activities comprises, by an electronic processing circuit of each of a plurality of mobile computing devices, receiving selections of a user corresponding to desired activities and starting times for each activity; by a transmitter of each of the plurality of mobile computing devices, transmitting the selections to an electronic processing circuit that is separate and distinct from the electronic processing circuit of the mobile computing device; by the separate and distinct electronic processing circuit, using the received selections from the plurality of mobile computing devices to: determine, for each user, waiting times associated with the desired starting times of at least one activity; determine, for each user, alternative starting times for the at least one activity, if existing, that have waiting times that are less than the waiting times for the desired starting times; and transmit existing alternative starting times to the mobile device associated with each user.

In a variation thereof, the method further includes receiving the existing alternative starting times by mobile computing devices, and by the electronic processing circuit for each mobile computing device receiving the existing alternative starting times, enabling a selection by the user of a received alternative starting time in place of a corresponding desired starting time.

In other variations thereof, the method further includes, by the separate and distinct electronic processing circuit, selecting alternative start times, for each user, which would operate to reduce a collective waiting time for all users if the alternative start times were selected by the users; including transmitting from the separate and distinct electronic processing circuit to each of the mobile computing devices, data corresponding to available activities; the data transmitted further includes available times for the available activities; and/or determining alternative start times includes comparing waiting times for alternative starting times for a given activity that are proximate in time to the desired starting time for the given activity.

In yet further variations thereof, the method further includes receiving a priority ranking for a plurality of desired activities, and transmitting the rankings with the selections; receiving a flexibility level associated with each of a plurality of selected activities, and transmitting the flexibility levels with the selections, the flexibility levels corresponding to an extent of starting time change that is acceptable; the separate and distinct processing circuit is used to manage a virtual queue for each activity; the mobile computing device is used to authenticate the user when the user arrives at to the activity at the starting time for the activity; the authentication is carried out using a machine readable code displayed upon the mobile computing device associated with the user; and/or the electronic processing circuit of the mobile computing device indicates to the user an impending starting time for an activity using at least one of a visual display, audible sound, and tactile output.

In still further variations thereof, the method further includes receiving a number of users to participate in each of the desired activities, and transmitting the number of users with the selections; the separate and distinct electronic processing circuit stores the desired starting times; the electronic processing circuit of each of the mobile computing devices enables a selection of either the original desired starting time, or the alternative starting time, and the mobile computing device transmits the selection to the separate and distinct electronic processing circuit; the transmitter of the mobile computing device transmits using a wireless transmission selected from short range wireless transmission and long range wireless transmission; and/or the venue is a fair or an amusement park, and a plurality of the activities are entertainment rides.

In another embodiment of the disclosure, a method of reducing user waiting time for the use of activities at a venue having multiple activities comprises, by an electronic processing circuit of each of a plurality of mobile computing devices, receiving selections of a user corresponding to desired activities and starting times for each activity; by a transmitter of each of the plurality of mobile computing devices, transmitting the selections to at least one electronic processing circuit that is separate and distinct from the electronic processing circuit of the mobile computing device; by the at least one separate and distinct electronic processing circuit, using the received selections from the plurality of mobile computing devices to: determine, for each user, waiting times associated with the desired starting times of at least one activity; determine, for each user, alternative starting times for the at least one activity, if existing, that have waiting times that are less than the waiting times for the desired starting times; transmit existing alternative starting times to the mobile device associated with each user; by the electronic processing circuit of each of the plurality of mobile computing devices: receive the alternative starting times, and displaying the alternative starting times in place of corresponding desired starting times; enable a selection of either the original desired starting time, or the alternative starting time; and transmit the selection of the original desired starting time to the at least one separate and distinct electronic processing circuit if selected.

In a variation thereof, at least one of the separate and distinct processing circuits is used to manage a virtual queue for each activity.

In a further embodiment of the disclosure, a system for reducing user waiting time for the use of activities at a venue having multiple activities, comprises an electronic processing circuit, in each of a plurality of mobile computing devices, configured for receiving selections of a user corresponding to desired activities and starting times for each activity; a transmitter in each of the plurality of mobile computing devices, configured for transmitting the selections to an electronic processing circuit that is separate and distinct from the electronic processing circuit of the mobile computing device; the separate and distinct electronic processing circuit, configured for using the received selections from the plurality of mobile computing devices to: determine, for each user, waiting times associated with the desired starting times of at least one activity; determine, for each user, alternative starting times for the at least one activity, if existing, that have waiting times that are less than the waiting times for the desired starting times; and transmit existing alternative starting times to the mobile device associated with each user.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts an application of the disclosure enabling a user to determine and submit an itinerary to be implemented in a virtual queue;

FIG. 2 depicts the application of FIG. 1, in which a server of the disclosure has recommended a closely matching alternative schedule with shorter waiting times, which can be accepted or rejected;

FIG. 3 depicts components of the server for integrating itineraries of all users, and managing queues for all queued activities;

FIG. 4 depicts the application of FIG. 1, where an alert has issued enabling the user to confirm intended attendance at an upcoming activity, and where the server has recommended an additional activity enabled by time freed by virtual queuing and schedule optimization;

FIG. 5 depicts two requested itineraries and their impact on queues for two activities;

FIG. 6 depicts changes to the two itineraries of FIG. 5, as suggested by the server, illustrating improvement to the queue for the two activities shown, as well as suggested changes to the itineraries for the two users which include reduced waiting time and more free time for other activities, which are suggested;

FIG. 7 illustrates an example server, all or portions of which can be used to carry out the disclosure; and

FIG. 8 illustrates an example mobile computing device, all or portions of which can be used to carry out the disclosure.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

Large events, theme parks, and other venues can attract many visitors, and often numerous visitors desire to participate in a limited number of total possible activities. This can pose challenges from an organizational point of view, since this can generate peaks of demand. As a result, long lines form which can negatively impact the client/customer/user experience. Moreover, managers of such events or amusement parks increase their incoming from selling merchandising, food, and drinks, which cannot conveniently be purchased while users are in line, causing additional losses for the venue.

From a business perspective, it is important therefore to try to minimize the time spent by users waiting in line, while maximizing the income deriving from ‘side-attractions’, such as stores and restaurants.

The disclosure provides an integrated global schedule generator which applies information regarding the interests of individual users to propose itineraries for each user that minimizes the waiting time for activities. Moreover, the system and method implements a virtual managed queue that does not require the physical presence of users in a line, optimizing the use of users' time, and improving the user experience. At the same time, there is the potential for increased income from side attractions, since users have more time to participate in such side attractions during the day. Further, the system can suggest side attractions to the customer during waiting time between activities.

The disclosure provides for optimizing user time in using one or more resources at a venue having a number of events, some or all of which are oversubscribed and require some waiting time to exploit. In an embodiment, the venue is an amusement park, although other venue types are contemplated, including for example a ticketing facility such as an airport or train station, an exposition or fair, an educational event, a zoo, a theme park, shopping mall, a movie at a theatre complex, or a promotional event.

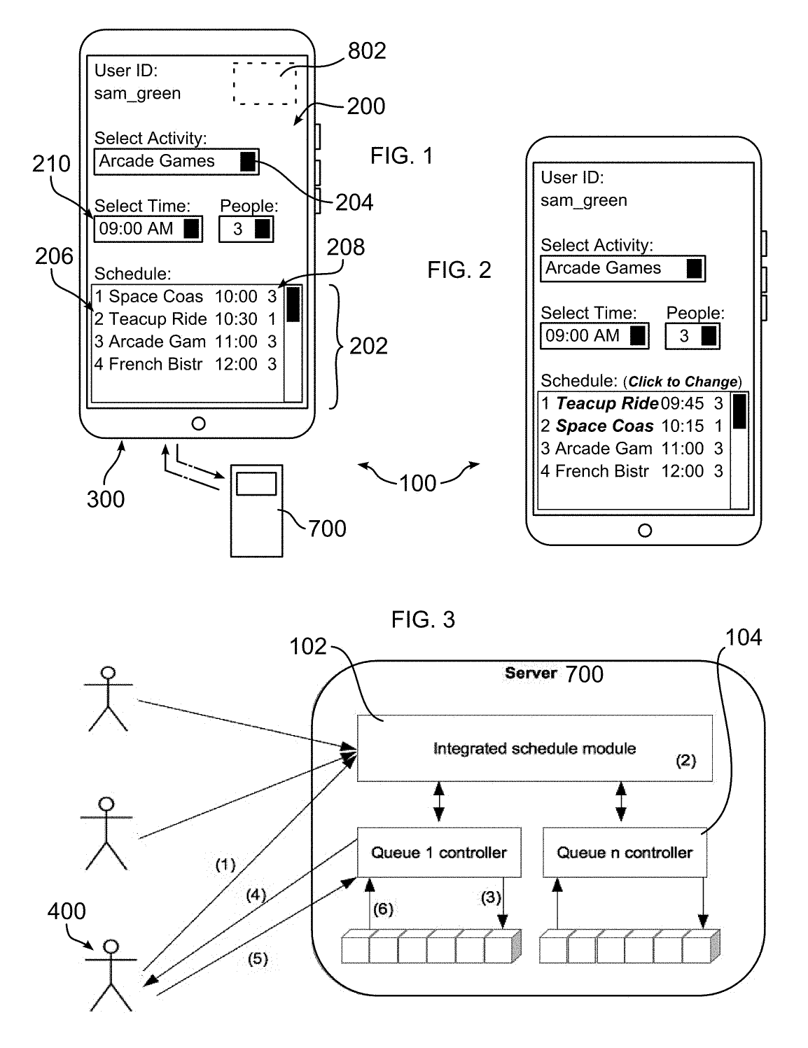

With reference to FIGS. 1-3, a process carried out by a system 100 of the disclosure can include the steps a user/customer submitting a list of events/activities 202 they desire to use/exploit/enjoy using an application 200 on a personal or mobile computing device 300, which includes a processor or other electronic computational circuit 802. The user may provide a ranking or preference order for the activities, representing a relative interest in the listed activities. The user can create the list using, for example, a dropdown list 204 of all available activities, and can rearrange the list, for example, by dragging the items. Other methods can be used to enable a user to select and reorder desired activities.

Application 200 can also be implemented in a desktop or fixed location computer, for example for advanced planning, however certain benefits would not be obtained. For example, without a mobile device, a user would not be reminded of upcoming activities, and system 100 could not recommend activities based upon a user's current location. Additionally, a user would not be able to conveniently change her schedule during the day.

Dropdown lists or other pick-lists of activities and available times, as well as locations of various types of food or shopping articles, are stored in a database available to server 700, and transmittable to mobile device 200, in order to populate and update such dropdown lists. In this manner, choices available using application 200 are current. For example, an activity that is closed for repairs would not appear as an eligible choice, or can be greyed out to indicate they are normally available, but not currently available.

Popular activities, and activities which have a very limited capacity, or which have a long duration, may have a queue or waiting line when there are more people desiring to use the activity than there are user slots available for the activity. Accordingly, if all users attended an activity based upon a ranking or desired time, there may be too many simultaneous users, resulting in long wait times. Thus, in accordance with the disclosure, a server 700 receives the user's submitted list using any transmission protocol, for example by a short range wireless transmission such as WiFi, nearfield, or BLUETOOTH, or a long range wireless transmission such as 4G, WiMAX, or LTE, and creates suggested alternatives or changes to each user's desired itinerary, considering the wait times for each activity, the suggested changes directed to minimize the wait time that would be required for the user at the activity. Server 700 can use the example algorithm provided elsewhere herein, or any other algorithm which reduces wait times for the user. For example, server 700 can suggest a time where there are fewer users desiring to attend a particular activity, and/or can suggest a time during which the user would be physically more proximate the activity.

In FIG. 1, in an embodiment, it may be seen that the user can select a desired time to attend a particular activity, for example using a time selecting software object 210. This can represent a method of ranking activities, for example by time. Alternatively, a ranking shown in the leftmost column 206 can represent a relative desire of the user to attend a particular event, regardless of the time of day. In this embodiment, the ranking can be changed by reordering the scheduled events, or by clicking the leftmost column which will invoke a software object which will allow a change in number, and which will then renumber the remaining items. Alternatively, clicking anywhere on a row can cause the display of an overlying dialog box which will enable changing any parameter on the row. There are numerous ways in which this can be implemented, as would be understood within the art.

In an embodiment, time selecting software object 210 only shows available times for a selected activity, the available times provided by server 700. Similarly, dropdown list 204 only shows activities which are available, the available activities provided by server 700.

Further in the embodiment shown, both a ranking and desired time are implemented by application 200. In an embodiment, a column 208 indicates a number of people to attend the event. This can be useful, for example, where one user creates an itinerary for a group, for example a family. The number of users that are allowed is authenticated by server 700, or a fee is adjusted based upon the number of users selected.

Additionally, server 700 receives a ranked list from one or more additional users visiting the venue, and coordinates the desired itinerary of all users so that overall wait times for all users is minimized, while attempting to match as close as possible the desired itinerary of each user. More particularly, if the anticipated wait times for all scheduled events for all users were summed, a goal would be to reduce this sum to the lowest possible value. This increases the overall efficiency of the venue, and enables maximal use of the venue by all users.

This is illustrated in FIG. 2, in which it is suggested by server 700, in this case using bold and italics, although other means of indication can be employed, to change the order of the Teacup Ride and the Space Coaster, and to start a bit earlier in the day. However, in accordance with the disclosure, a user can reject a suggested time, although this may result in a longer wait time for that user, and an overall slight reduction in efficiency for the venue. In the embodiment illustrated the user clicks the suggested row, and makes the desired changes, or the user can be given the opportunity to revert to a previous time or ranking. Once such changes are made, an itinerary for other users may change, and be indicated similarly for the other users. Ultimately, server 700 may not enable a user to change a suggested revision, for example where such change is impossible, or where the change would cause too many conflicts with other users, although this is avoided whenever possible.

In an embodiment, application 200 displays the waiting time for the desired schedule, as well as the recommended schedule, so that the user can determine the relative value of adhering to a desired schedule, or accepting the recommended changes. For example, the wait time can be displayed along the row corresponding to the scheduled event, or the user could tap or click to see a submenu including the estimated waiting time.

To coordinate the itineraries of all users participating with a mobile computing device, server 700 considers the total requests for each activity, historical wait times at various times during the day for each activity, travel times between activities, the duration of each activity, the hours during which the activity operates, the number of slots or capacity of the activity, and special needs of certain users which can impact capacity or duration, such as exceptional physical requirements.

To reduce or eliminate a need for users to line up for an activity, server 700 can implement a virtual queue, where a listing of users and their relative priority for use of an activity is stored in a computer database. Users participating with their mobile phone can be advised of when they are expected at the activity for admission. At the activity, the user can present their mobile device or an ID for authentication, and administration at the activity can check the authentication against the database. In various embodiments, an application of system 100 executing upon a processing circuit of the mobile device causes the display of a QR code, bar code, or other machine readable authentication which encodes a value that can be read at the event to authenticate that the holder of the mobile device is authorized to access the activity at a particular time. Alternatively, a human readable indication can likewise be displayed upon the mobile device.

With a virtual queue, server 700 can determine if a user has free time before they are scheduled to participate in an activity, and using location services information available from the user's mobile device, can suggest time-filling activities which are nearby to the user, which may be of interest to the user, and which can be enjoyed within the time available.

After each predetermined space of time required for the completion of an event has passed, a new slot of users virtually move to the first positions of the virtual queue, and these users are convoked to the starting position of the event. Server 700 sends a message to the mobile device 300 associated with the queued user at a sufficient time before the activity begins, whereby the user can travel to the activity without haste. Once the user has manually or automatically indicated they are present and authorized by server 700 to participate in the activity, the user is removed from the virtual queue of the event and the wait time for the event is reduced.

As part of an optimization performed by server 700, alternative activities are scheduled between activities. These alternative activities can include shopping, snacking, staying at home, resting, sight-seeing, and dining, for example. The user can indicate they would like to participate in such activities using the mobile application 200, or server 700 can remind the user to include such activities in their itinerary, for example by inserting such activities which the user can then accept or reject.

Accordingly, the disclosure promotes free choice by users within the venue, while also globally organizing all virtual queues. In this manner, users can accept recommendations which reduce their wait time, as well as the wait time of all users, or they can reject recommendations on an activity by activity basis, based on their willingness to tolerate some inefficiency. Ultimately, even considering the rejection of some recommendations, the overall efficiency of the venue is greatly improved by system 100. Additionally, system 100 increases revenue for a venue, not only by optimizing participation in all activities, but by providing time and reminders to users regarding shopping, refreshments, and other side activities ancillary to the main activities.

In an embodiment, sensors can monitor the size of physical queues, and this information can be provided to server 700 so that a more accurate prediction of waiting time can be derived, which includes users in virtual queues, as well as users in physical queues. Such sensors can, for example, employ cameras and software object recognition to identify people, can sense a number of mobile computing devices within a waiting area, and can detect and count users as they enter a waiting area.

In an embodiment, with reference to FIG. 3, in step (1), a user 400 submits the list of activities that she desires to attend, as described elsewhere herein. In step (2), server 700 creates a schedule using an ‘Integrated schedule module’ 102 which includes a circuit which executes instructions which can be stored on non-transitory machine readable media. The circuit receives data input regarding virtual queues, for example from one or more queue controllers 104 which can be separate processing circuits or software executing upon server 700. The data input corresponds to a number of users in queue for each activity. By factoring in the number of users in every queue, an impact of a schedule change for any individual user can be determined for all users. Each users schedule can therefore be optimized individually, and in consideration of the impact on all users, for example by determining an impact on the total waiting time for all users at the venue, as described herein.

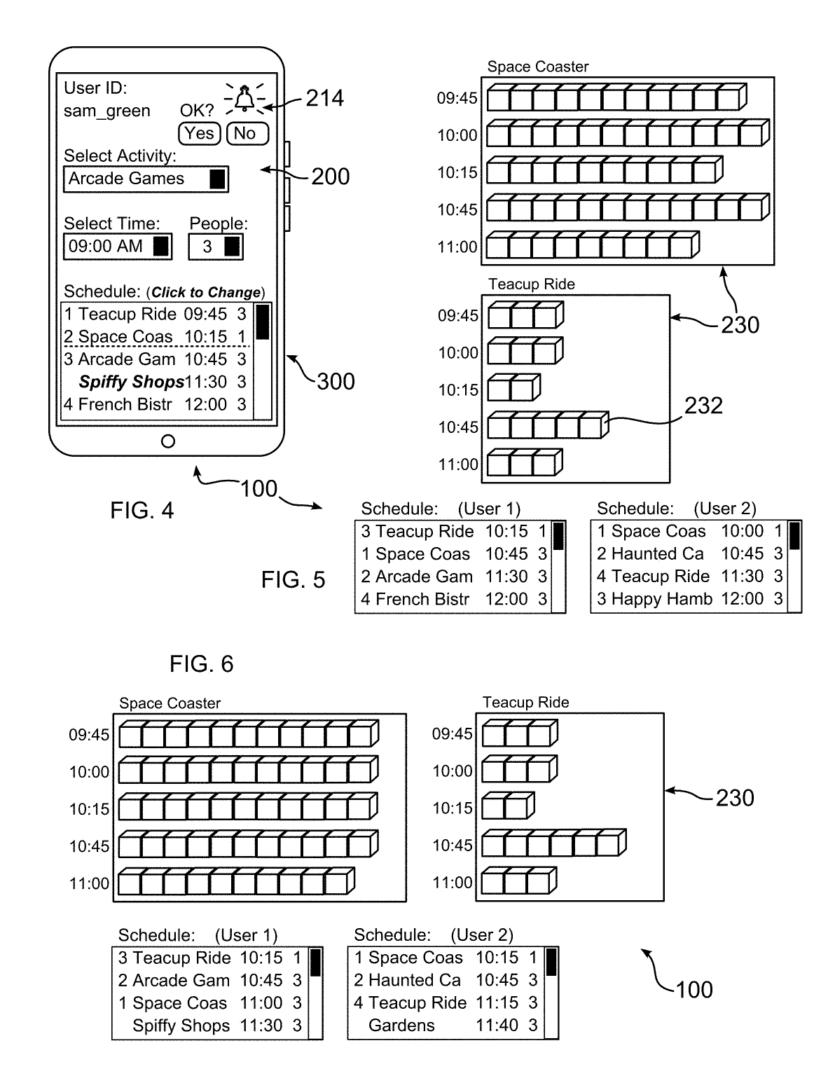

In step (3), server 700 adds a user to one or more virtual queues corresponding to the requested activities, and causes an update of the waiting time at each attraction. If the user's desired schedule is not efficient for the user and/or all users, suggested schedule changes are made in step (4). After each predetermined space of time required for the completion of a use cycle of an activity, a new slot of users in the first position of the virtual queue for an event are convoked to the starting position of the attraction, as also illustrated by arrow (4). Server 700, for example through the queue controller 104, sends a message to the listed mobile device of the convoked user some minutes before the attraction begins, as further illustrated in FIG. 4.

In step (5), the user has authenticated or otherwise indicated their arrival at the activity. in step (6), that user is removed from the virtual queue of the activity, and the waiting time of the activity is updated.

With reference to FIG. 4, an alert 214 has been invoked by application 200, and an upcoming event has been underlined. In an embodiment, user 400 can indicate they plan to participate as scheduled by pressing Yes, or can cancel participation by pressing No. In either case, one or more indications of the alarm, which can be visible, audible, or tactile, is cancelled.

If the user indicates No, server 700 can examine the queues of all users and determine if a user would like to have the slot abandoned by the user of the mobile device of FIG. 4. Accordingly, where a desired time slot was previously not available and an alternative was proposed and accepted, server 700 can compare the newly available slot with stored unmet original request, and compare such unmet requests with any newly available slots, and propose to another user to schedule a newly available slot.

Where multiple users have requested a particular slot that later becomes available, a user is selected for proposing the slot based upon, for example, a proximity of the user to the activity. Alternatively, a user can request, or pay a premium, to be offered a newly available slot. In a further alternative, a user who has won a contest can be granted a newly available slot.

Also illustrated in FIG. 4, server 700 has determined that less time is needed for the Space Coaster ride, because a queue has been avoided. As a result, time at the Arcade Games can be moved earlier, and can be concluded earlier, leaving time for a side event. In this case, based on proximity to the Arcade Games or the French Bistro, server 700 has recommended a visit to the Spiffy Shops, where the user can purchase souvenirs or other items that may be of interest. A user can accept or reject the proposal as described elsewhere herein.

An example global scheduling change is shown in FIGS. 5-6. In the figures, the rectangular bounding boxes 230 each represent the maximum capacity for an activity. As can be seen in FIG. 5, based upon the requested schedule of User 1 and User 2, depicted below the ride queues, Space Coaster is at capacity at 10:00 and 10:45. It should be understood that the illustrations are simplified to clarify the concepts, and that User 1 and User 2, as a practical matter, would likely represent many users with a similar scheduling request, and that each box 232 indicating the queue length, can represent many users scheduled. Additionally, in most applications, there are many activities, and many different user schedules.

In FIG. 6, the integrated schedule module 102 of server 700 has now recommended, for User 1, to swap the order of visiting the Arcade Games activity and the Space Coaster activity, to relieve waiting time for User 1 as well as other users at the capacity time slot of 10:45, filling in the greater capacity available at 11:00. The queue for the Arcade Games is not shown here, but it may be assumed that the activity is not at capacity. Otherwise, this could impact the schedule further.

Similarly, for User 2 (which, as noted, could represent numerous similar requests), the requested use of Space Coaster at 10:00 falls during a peak capacity time. Accordingly, server 700 recommends moving the Space Coaster use to 10:15, where greater capacity and shorter waiting times are available. Because the wait time in line has been reduced due to the move, User 2 does not need to reschedule the Haunted Castle visit. Server 700 has identified that the time needed for the Haunted Castle has been reduced, due to shortened queue times, and also that the Teacup Ride does not need as much time as requested, and therefore recommends reducing this time period and participating in a new side attraction, a stroll in the Gardens, before lunch at the Happy Hamburger (which has scrolled off-screen). In this example, the Haunted Castle activity does not need to be rescheduled, which is advantageous if this activity is also close to capacity.

To determine an optimized schedule for all users, an approach can be to test for a best fit for each user, as described herein, and to then iterate through all users to address poor fits between desired schedules and available schedules, until an optimal compromise is established which reflects a similar quality of fit for all users. A best fit represents a compromise due to a finite availability of resources, which can include a maximum capacity for an activity, a required travel time between successively scheduled activities, and a limitation or preference of the user, the best fit in one embodiment being defined by a schedule of activities which most closely approximates the desired schedule, where start times for events are changed is little as possible in order to obtain a significant reduction in waiting time. In an embodiment, a user can indicate to application 200, for each activity, a level of flexibility in the schedule for that activity that would be deemed acceptable. In this manner a better fit is more readily obtained.

Alternatively, a best fit can be determined for each user in the order in which desired itineraries are received. In a further alternative, a mix of both of the foregoing methodologies is employed, where earlier requests are weighted higher than later requests. Regardless of the method, it may be that when an activity is close to a scheduled time for a user, no change can be made for that event, for that user.

Mathematical Formulation of the Problem

To carry out the disclosure and optimize overall waiting time, the following algorithm can be employed, although it should be understood that other algorithms are possible. It is assumed here that time is measured in discrete units, so all the time-related values are integer numbers belonging to some set T={0, 1, . . . ,T}, TεN.

Problem Description:

We are given a set U={u₁, . . . uₘ} of users (or visitors) and a set A={a₁, . . . aₙ} of attractions. Each sequence Sₐ={s_{a,1},s_{a,2}, . . . ,s_{a,k}} contains the available time slots for attraction a. We assume that the slots are ordered in time and that slot s_{a,j} starts at time t(s_{a,j}). The maximum number of users that can attend an attraction a in each time slot is denoted by cₐ. Each user u is interested in a set Aᵤ⊂A of activities, and we assume that she can only be assigned to time slots starting after time sᵤ.

We assume that the amount of time that every user needs in order to go from the location of activity a to the location of a′ is given by d(a, a′). Finally C(a, s)={(a′, s′):(s≦s′ and s+d(aₘ, a₁)≧s′) or (s′≦s and s′+d(a₁, aₘ)≧s)}, aεA and sεSₐ, i.e. C(a, s) contains all the combinations (a′, s′) indicating a time slot s′ of some activity a′ that overlaps with the time slot s of activity a, which basically means that these two assignments cannot belong to a same visit plan.

Problem Resolution:

In accordance with the disclosure, the following Mixed Integer Linear Programming formulation is used to resolve the problem.

This model employs binary variables x_{u,a,s} indicating that user u is assigned to the time slot s of attraction a and nonnegative variables eᵤ representing the starting time of the last attraction

$$\begin{matrix}( X ) & \\ min {\sum }_{u ∈} {e}_{u} & \\ \begin{matrix}{\sum }_{s ∈ {S}_{a}} {x}_{u , a , s} = 1 & ∀ u ∈ , a ∈ {A}_{u}\end{matrix} & ( i ) \\ \begin{matrix}{\sum }_{u ∈} {x}_{u , a , s} \leq {c}_{a} & ∀ a ∈ , s ∈ {S}_{a}\end{matrix} & ( ii ) \\ \begin{matrix}{\sum }_{( {a}^{′} , {s}^{′} ) ∈ C ( a , s )} {x}_{u , {a}^{′} , {s}^{′}} \leq M ( 1 - {x}_{u , a , s} ) & ∀ ( u , a , s ) ∈ \times \times {S}_{a}\end{matrix} & ( iii ) \\ \begin{matrix}{\sum }_{s ∈ {S}_{a}} t ( s ) {x}_{u , a , s} \leq {e}_{u} & ∀ ( u , a ) ∈ \times \end{matrix} \\ \begin{matrix}{e}_{u} ∈ {+}^{} & ∀ u ∈\end{matrix} \\ \begin{matrix}{x}_{u , a , s} ∈ \{ 0 , 1 \} & ∀ ( u , a , s ) ∈ \times \times {S}_{a} .\end{matrix} & ( iv )\end{matrix}$$

that will be attended by u. Variable x_{u,a,s} is not incorporated to the model if t(s)<sₐ.

Equation (X)(i) asserts that each user u is assigned to exactly one time slot s in Sₐ for every attraction in Aᵤ, i.e., every user attends all the events she wants to. Inequality (X)(ii) ensures that the capacity of every attraction a is respected for every time slot s. If assignment (u, a, s) is chosen, Inequality (X)(iii) asserts that no other assignment (u, a′, s′) for (a′, s′)εC(a, s) is also incorporated to the solution. Finally. Inequalities (X)(iv) are used to compute the starting time of the last attraction that will be attended by u.

In another example, a user arrives at an amusement park and, using mobile application 200 deployed on their smartphone, informs system 100 that she would like to ride the Ferris wheel, the roller coaster, and the carrousel. Additionally, she indicates that she wants to try a snack of a piece of pizza during the visit, and to buy a teddy bear and T-shirts. Thus, in this example, the user does not provide a desired timeframe to application 200, although this is possible as described herein. Additionally, a text box enables her, when she selects a ‘shopping’ activity, to enter search criteria for the type of article she wishes to shop for. In this example, she enters ‘T-shirt’ and ‘teddy bear’.

When the user information is received, by any protocol known or hereinafter developed, including wired or wireless protocols, server 700 initially identifies that the user might be interested in visiting snack bar ‘1’, which serves pizza, store ‘3’ that sells T-shirts, and store ‘5’, which specialized in toys. The integrated scheduling module 102 also identifies a logical order in which to participate in all events, including amusement, eating, and shopping activities, based on known habits of visitors, and distances and travel time between activities, and develops a tentative schedule. System 100 then determines the shortest waiting times of the selected activities based on current and historical waiting times, which best match the tentative schedule, and revises the schedule to produce the shortest waiting times for the user, as well as all users.

For example, the waiting times are determined to be: Ferris wheel—2 hours; Roller Coaster—50 minutes; and Carrousel—20 minutes. It is determined there is no significant waiting times for the restaurant and shops. Based on this information, the integrated scheduling module generates the customer's schedule in this order: 1—Carrousel, 2—Roller Coaster, 3—time for a snack, 4—Ferris wheel, and 5—time for shopping.

At that time, the customer is added to the queue of each activity. System 100 calculates that the amount time that the user spends waiting for attraction #1 is also applied against the wait times for attractions #2 and #3. In this case, if the user originally waited twenty minutes for the Carrousel, this time is also deducted from the wait times for the Ferris wheel and the Roller Coaster. As such, after this first waiting period, there is thirty minutes waiting time left for the Roller Coaster, and one hour and forty minutes waiting time left for the Ferris wheel. System 100 also finds large gaps between the attractions to suggest side-attractions, such as the time for a snack, and for shopping.

Accordingly, the disclosure provides a system 700 with which, using a mobile computing device 300, a kiosk at the venue, a home or work computer, or any other computing device, to virtually organize their day, or series of days, at a venue with numerous activities. A circuit of server 700 performs calculations based on current and historical queue times for the various attractions, such as may be impacted, for example, by seasons or weather, and the requested activities of all other users for which information is available, and develops an itinerary that best meets a requested itinerary of the requesting user, and all other users.

While embodiments have been described herein in which the user is very specific regarding the activities they wish to participate in, and the times at which they would like to participate, other embodiments select the particular activity, or the particular time. In addition, users can enter profile information, for example including allergies or physical limitations, likes and dislikes with respect to types of rides or activities, types of articles to buy, and pace of activity, and server 700 will propose an itinerary that best meets the profile, while optimizing wait times for the user and all other users at the venue. This profile information can be stored in a database, if the user prefers, so that it can be accessed during future visits to the venue.

In an embodiment, application 200 dynamically provides information regarding a limited set of upcoming events, as opposed to a schedule for an entire day, for example. In this way, system 100 can reconfigure schedules for all affected users based on changes to a particular user's schedule, with the least amount of published changes to user schedules.

Example Computing System

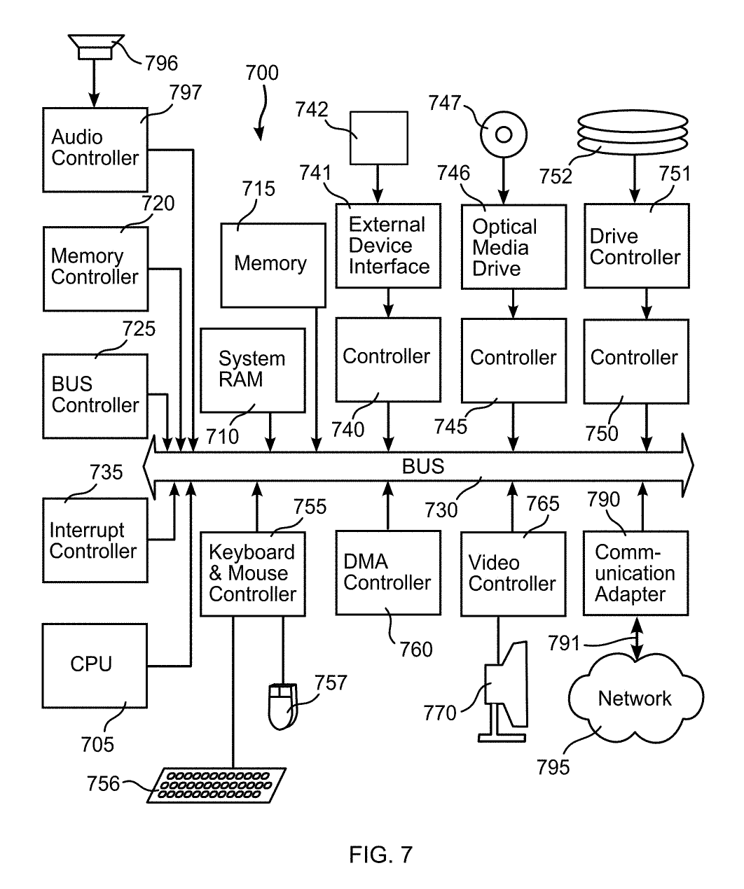

FIG. 7 illustrates the system architecture for a computer system 700 which can be a computer server, and which can include the functions of a process controller, or other processor on which or with which the disclosure may be implemented. The exemplary computer system of FIG. 7 is for descriptive purposes only. Although the description may refer to terms commonly used in describing particular computer systems, the description and concepts equally apply to other systems, including systems having architectures dissimilar to FIG. 7. Computer system 700 can control temperatures, motors, pumps, flow rates, power supplies, ultrasonic energy power generators, and valves, using actuators and transducers. One or more sensors, not shown, provide input to computer system 700, which executes software stored on non-volatile memory, the software configured to received inputs from sensors or from human interface devices, in calculations for controlling system 200.

Computer system 700 includes at least one central processing unit (CPU) 705, or server, which may be implemented with a conventional microprocessor, a random access memory (RAM) 710 for temporary storage of information, and a read only memory (ROM) 715 for permanent storage of information. A memory controller 720 is provided for controlling RAM 710.

A bus 730 interconnects the components of computer system 700. A bus controller 725 is provided for controlling bus 730. An interrupt controller 735 is used for receiving and processing various interrupt signals from the system components.

Mass storage may be provided by DVD ROM 747, or flash or rotating hard disk drive 752, for example. Data and software, including software 102 of the disclosure, may be exchanged with computer system 700 via removable media such as diskette, CD ROM, DVD, Blu Ray, or other optical media 747 connectable to an Optical Media Drive 746 and Controller 745. Alternatively, other media, including for example a media stick, for example a solid state USB drive, may be connected to an External Device Interface 741, and Controller 740. Additionally, another computing device can be connected to computer system 700 through External Device Interface 741, for example by a USB connector, BLUETOOTH connector, Infrared, or WiFi connector, although other modes of connection are known or may be hereinafter developed. A hard disk 752 is part of a fixed disk drive 751 which is connected to bus 730 by controller 750. It should be understood that other storage, peripheral, and computer processing means may be developed in the future, which may advantageously be used with the disclosure.

User input to computer system 700 may be provided by a number of devices. For example, a keyboard 756 and mouse 757 are connected to bus 730 by controller 755. An audio transducer 796, which may act as both a microphone and a speaker, is connected to bus 730 by audio controller 797, as illustrated. It will be obvious to those reasonably skilled in the art that other input devices, such as a pen and/or tablet, Personal Digital Assistant (PDA), mobile/cellular phone and other devices, may be connected to bus 730 and an appropriate controller and software, as required. DMA controller 760 is provided for performing direct memory access to RAM 710. A visual display is generated by video controller 765 which controls video display 770. Computer system 700 also includes a communications adapter 790 which allows the system to be interconnected to a local area network (LAN) or a wide area network (WAN), schematically illustrated by bus 791 and network 795.

Operation of computer system 700 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 705 coordinates the operation of the other elements of computer system 700. The present disclosure may be implemented with any number of commercially available operating systems.

One or more applications, such as an HTML page server, or a commercially available communication application, may execute under the control of the operating system, operable to convey information to a user.

Example Mobile Computing System

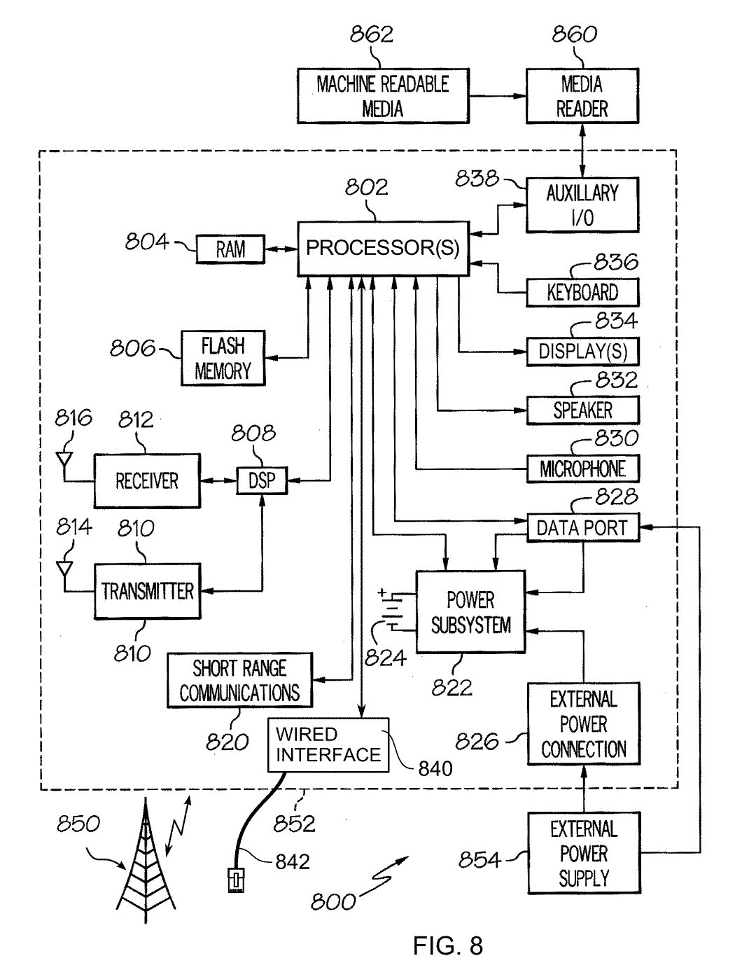

FIG. 8, is a block diagram of an electronic device and associated components 800, which can be used in carrying out the disclosure. Mobile computing device 300 can include one or all of the components of device 800. In this example, an electronic device 852 is a wireless two-way communication device with voice and data communication capabilities. Such electronic devices communicate with a wireless voice or data network 850 using a suitable wireless communications protocol. Wireless voice communications are performed using either an analog or digital wireless communication channel. Data communications allow the electronic device 852 to communicate with other computer systems via the Internet. Examples of electronic devices that are able to incorporate the above described systems and methods include, for example, a data messaging device, a two-way pager, a cellular telephone with data messaging capabilities, a wireless Internet appliance or a data communication device that may or may not include telephony capabilities.

The illustrated electronic device 852 is an example electronic device that includes two-way wireless communications functions. Such electronic devices incorporate communication subsystem elements such as a wireless transmitter 810, a wireless receiver 812, and associated components such as one or more antenna elements 814 and 816. A digital signal processor (DSP) 808 performs processing to extract data from received wireless signals and to generate signals to be transmitted. The particular design of the communication subsystem is dependent upon the communication network and associated wireless communications protocols with which the device is intended to operate.

The electronic device 852 includes an electronic computational circuit, for example a microprocessor 802, that controls the overall operation of the electronic device 852. The microprocessor 802 interacts with the above described communications subsystem elements and also interacts with other device subsystems such as flash memory 806, random access memory (RAM) 804, auxiliary input/output (I/O) device 838, data port 828, display 834, keyboard 836, speaker 832, microphone 830, a short-range communications subsystem 820, a power subsystem 822, and any other device subsystems.

A battery 824 is connected to a power subsystem 822 to provide power to the circuits of the electronic device 852. The power subsystem 822 includes power distribution circuitry for providing power to the electronic device 852 and also contains battery charging circuitry to manage recharging the battery 824. The power subsystem 822 includes a battery monitoring circuit that is operable to provide a status of one or more battery status indicators, such as remaining capacity, temperature, voltage, electrical current consumption, and the like, to various components of the electronic device 852.

The data port 828 of one example is a receptacle connector 104 or a connector that to which an electrical and optical data communications circuit connector 800 engages and mates, as described above. The data port 828 is able to support data communications between the electronic device 852 and other devices through various modes of data communications, such as high speed data transfers over an optical communications circuits or over electrical data communications circuits such as a USB connection incorporated into the data port 828 of some examples. Data port 828 is able to support communications with, for example, an external computer or other device.

Data communication through data port 828 enables a user to set preferences through the external device or through a software application and extends the capabilities of the device by enabling information or software exchange through direct connections between the electronic device 852 and external data sources rather than via a wireless data communication network. In addition to data communication, the data port 828 provides power to the power subsystem 822 to charge the battery 824 or to supply power to the electronic circuits, such as microprocessor 802, of the electronic device 852.

Operating system software used by the microprocessor 802 is stored in flash memory 806. Further examples are able to use a battery backed-up RAM or other non-volatile storage data elements to store operating systems, other executable programs, or both. The operating system software, device application software, or parts thereof, are able to be temporarily loaded into volatile data storage such as RAM 804. Data received via wireless communication signals or through wired communications are also able to be stored to RAM 804.

The microprocessor 802, in addition to its operating system functions, is able to execute software applications on the electronic device 852. A predetermined set of applications that control basic device operations, including at least data and voice communication applications, is able to be installed on the electronic device 852 during manufacture. Examples of applications that are able to be loaded onto the device may be a personal information manager (PIM) application having the ability to organize and manage data items relating to the device user, such as, but not limited to, e-mail, calendar events, voice mails, appointments, and task items.

Further applications may also be loaded onto the electronic device 852 through, for example, the wireless network 850, an auxiliary I/O device 838, Data port 828, short-range communications subsystem 820, or any combination of these interfaces. Such applications are then able to be installed by a user in the RAM 804 or a non-volatile store for execution by the microprocessor 802.

In a data communication mode, a received signal such as a text message or web page download is processed by the communication subsystem, including wireless receiver 812 and wireless transmitter 810, and communicated data is provided the microprocessor 802, which is able to further process the received data for output to the display 834, or alternatively, to an auxiliary I/O device 838 or the Data port 828. A user of the electronic device 852 may also compose data items, such as e-mail messages, using the keyboard 836, which is able to include a complete alphanumeric keyboard or a telephone-type keypad, in conjunction with the display 834 and possibly an auxiliary I/O device 838. Such composed items are then able to be transmitted over a communication network through the communication subsystem.

For voice communications, overall operation of the electronic device 852 is substantially similar, except that received signals are generally provided to a speaker 832 and signals for transmission are generally produced by a microphone 830. Alternative voice or audio I/O subsystems, such as a voice message recording subsystem, may also be implemented on the electronic device 852. Although voice or audio signal output is generally accomplished primarily through the speaker 832, the display 834 may also be used to provide an indication of the identity of a calling party, the duration of a voice call, or other voice call related information, for example.

Depending on conditions or statuses of the electronic device 852, one or more particular functions associated with a subsystem circuit may be disabled, or an entire subsystem circuit may be disabled. For example, if the battery temperature is low, then voice functions may be disabled, but data communications, such as e-mail, may still be enabled over the communication subsystem.

A short-range communications subsystem 820 provides for data communication between the electronic device 852 and different systems or devices, which need not necessarily be similar devices. For example, the short-range communications subsystem 820 includes an infrared device and associated circuits and components or a Radio Frequency based communication module such as one supporting Bluetooth® communications, to provide for communication with similarly-enabled systems and devices, including the data file transfer communications described above. A wired interface 840 and connector 842 can be provided, configured to support any known wired communication protocol, for example USB.

A media reader 860 is able to be connected to an auxiliary I/O device 838 to allow, for example, loading computer readable program code of a computer program product into the electronic device 852 for storage into flash memory 806. One example of a media reader 860 is an optical drive such as a CD/DVD drive, which may be used to store data to and read data from a computer readable medium or storage product such as computer readable storage media 862. Examples of suitable computer readable storage media include optical storage media such as a CD or DVD, magnetic media, or any other suitable data storage device. Media reader 860 is alternatively able to be connected to the electronic device through the Data port 828 or computer readable program code is alternatively able to be provided to the electronic device 852 through the wireless network 850. Sensors 870 can be provided either internal or external to a housing of device 300/800, of any of the various types and functions as described herein.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A method of reducing user waiting time for the use of activities at a venue having multiple activities, the method comprising:
by an electronic processing circuit of each of a plurality of mobile computing devices, receiving selections of a user corresponding to desired activities and starting times for each activity;
by a transmitter of each of the plurality of mobile computing devices, transmitting the selections to an electronic processing circuit that is separate and distinct from the electronic processing circuit of the mobile computing device;
by the separate and distinct electronic processing circuit, using the received selections from the plurality of mobile computing devices to:
determine, for each user, waiting times associated with the desired starting times of at least one activity;
determine, for each user, alternative starting times for the at least one activity, if existing, that have waiting times that are less than the waiting times for the desired starting times; and
transmit existing alternative starting times to the mobile device associated with each user.

2. The method of claim 1, further including receiving the existing alternative starting times by mobile computing devices, and by the electronic processing circuit for each mobile computing device receiving the existing alternative starting times, enabling a selection by the user of a received alternative starting time in place of a corresponding desired starting time.

3. The method of claim 2, further including, by the separate and distinct electronic processing circuit, selecting alternative start times, for each user, which would operate to reduce a collective waiting time for all users if the alternative start times were selected by the users.

4. The method of claim 1, further including transmitting from the separate and distinct electronic processing circuit to each of the mobile computing devices, data corresponding to available activities.

5. The method of claim 4, where the data transmitted further includes available times for the available activities.

6. The method of claim 1, wherein determining alternative start times includes comparing waiting times for alternative starting times for a given activity that are proximate in time to the desired starting time for the given activity.

7. The method of claim 1, further including receiving a priority ranking for a plurality of desired activities, and transmitting the rankings with the selections.

8. The method of claim 1, further including receiving a flexibility level associated with each of a plurality of selected activities, and transmitting the flexibility levels with the selections, the flexibility levels corresponding to an extent of starting time change that is acceptable.

9. The method of claim 1, wherein the separate and distinct processing circuit is used to manage a virtual queue for each activity.

10. The method of claim 1, wherein the mobile computing device is used to authenticate the user when the user arrives at to the activity at the starting time for the activity.

11. The method of claim 10, wherein the authentication is carried out using a machine readable code displayed upon the mobile computing device associated with the user.

12. The method of claim 1, wherein the electronic processing circuit of the mobile computing device indicates to the user an impending starting time for an activity using at least one of a visual display, audible sound, and tactile output.

13. The method of claim 1, further including receiving a number of users to participate in each of the desired activities, and transmitting the number of users with the selections.

14. The method of claim 1, wherein the separate and distinct electronic processing circuit stores the desired starting times.

15. The method of claim 1, wherein the electronic processing circuit of each of the mobile computing devices enables a selection of either the original desired starting time, or the alternative starting time, and the mobile computing device transmits the selection to the separate and distinct electronic processing circuit.

16. The method of claim 1, wherein the transmitter of the mobile computing device transmits using a wireless transmission selected from short range wireless transmission and long range wireless transmission.

17. The method of claim 1, wherein the venue is a fair or an amusement park, and a plurality of the activities are entertainment rides.

18. A method of reducing user waiting time for the use of activities at a venue having multiple activities, the method comprising:
by an electronic processing circuit of each of a plurality of mobile computing devices, receiving selections of a user corresponding to desired activities and starting times for each activity;
by a transmitter of each of the plurality of mobile computing devices, transmitting the selections to at least one electronic processing circuit that is separate and distinct from the electronic processing circuit of the mobile computing device;
by the at least one separate and distinct electronic processing circuit, using the received selections from the plurality of mobile computing devices to:
determine, for each user, waiting times associated with the desired starting times of at least one activity;
determine, for each user, alternative starting times for the at least one activity, if existing, that have waiting times that are less than the waiting times for the desired starting times;
transmit existing alternative starting times to the mobile device associated with each user;
by the electronic processing circuit of each of the plurality of mobile computing devices:
receive the alternative starting times, and displaying the alternative starting times in place of corresponding desired starting times;
enable a selection of either the original desired starting time, or the alternative starting time; and
transmit the selection of the original desired starting time to the at least one separate and distinct electronic processing circuit if selected.

19. The method of claim 18, wherein at least one of the separate and distinct processing circuits is used to manage a virtual queue for each activity.

20. A system for reducing user waiting time for the use of activities at a venue having multiple activities, comprising:
an electronic processing circuit, in each of a plurality of mobile computing devices, configured for receiving selections of a user corresponding to desired activities and starting times for each activity;
a transmitter in each of the plurality of mobile computing devices, configured for transmitting the selections to an electronic processing circuit that is separate and distinct from the electronic processing circuit of the mobile computing device;
the separate and distinct electronic processing circuit, configured for using the received selections from the plurality of mobile computing devices to:
determine, for each user, waiting times associated with the desired starting times of at least one activity;
determine, for each user, alternative starting times for the at least one activity, if existing, that have waiting times that are less than the waiting times for the desired starting times;
transmit existing alternative starting times to the mobile device associated with each user.
